(19) United States
(12) Patent Application Publication
(10) Pub. No.: US 2006/0229878 A1
(43) Pub. Date: Oct. 12, 2006

(54) Waveform recognition method and apparatus

(76) Inventor: Eric Scheirer, Somerville, MA (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/855,776

(22) Filed: May 27, 2004

Related U.S. Application Data
(60) Provisional application No. 60/473,502, filed on May 27, 2003.

(51) Int. Cl. G10L 21/00

(52) U.S. Cl. 704/273

(57) ABSTRACT

A new method for extracting fingerprints from waveforms (e.g. musical signals) is disclosed, alosng with exemplary apparatus for doing same, all being particularly useful for recogizing waveforms. The new method is based on the principle of calculating features based on in-band frequency changes over time, in addition to the in-band amplitude changes over time considered by previous method according to the present invention s. Database lookup using these fingerprints is robust to a variety of changes that impair the signal, include lossy coding/decoding; dynamic compression; speed change; mixture with interfering signals, including speech and white noise at 0 dB SNR; and convolution with complex filters, including the effect of cell-phone transmission in an error-prone channel. The new method's performance has been evaluated on a large set of controlled test cases. Optimizations for improving search efficiency on large databases with approximate matching are also discussed.

### PRIOR APPLICATION

This application claims priority of provisional patent application 60/473,502 filed May 27, 2003.

All references cited, identified, listed, and/or made herein are hereby incorporated by reference in their entirety and for all purposes.

### BACKGROUND OF THE INVENTION

In many applications, it is desirable to rapidly check whether an audio signal contains a certain piece of music, or one of a set of pieces of music. For example, in broadcast airplay monitoring, advertisers and music copyright owners wish to automatically monitor the signal to determine when their content assets are being aired. A technology solution frequently applied to this problem has come to be called music fingerprinting, which will be taken herein to mean the computation of short sequences that can be used to identify a piece of music.

In broad terms, the most-common music fingerprinting application operates as follows. A database of music is created and used to generate a set of standard fingerprints, which will be termed templates in the present paper. The creation of template fingerprints can typically be accomplished offline, out of realtime if necessary. Then, in the course of the deployed application, a target signal is received. The fingerprint of the target signal is computed and rapidly matched against all of the templates. This determines whether or not the target signal contains any segments drawn from any of the pieces in the music database. If a match is found, metadata that identifies the matching fingerprint becomes the subject of further processing, for example for billing purposes.

In such an application, the fingerprint comparison acts as proxy for a more general perceptual similarity comparison [1](Note: the material in this footnote, and all other naterial rferenced by footnote or otherwise herein, is hereby incorporated by reference.) Ideally, the fingerprint comparison can be done very rapidly, in or near realtime, even with very large databases containing hundreds of thousands of pieces of music. Computing a truer perceptual comparison based on psychoacoustic first-principles would be prohibitively expensive computationally. Also in the ideal, the fingerprint is much smaller in terms of data size than the piece of music it represents, allowing such large databases to be represented efficiently on single-hard-disk systems.

For example, assume that a typical piece of uncompressed music requires 10 MB per minute of high-quality sound. Then a database containing 100,000 tracks, averaging 4 min in length apiece, requires 4,000,000 MB of storage—not a simple requirement today. Even if compressed with state of the art perceptual coding [2], this amount of music would require at least 200,000 MB to store. But if a fingerprint that represents some robust feature of the music requires only 10 KB per minute, then the same database would take only 2,000 MB, a much more reasonable demand.

Music fingerprinting likely started with the work of Kenyon, turned into products in the late 1980s by Broadcast Data Systems, a company which is in the business of airplay monitoring. While Kenyon's methods seem never to have been published in the scientific literature, there are a number of patent filings regarding his systems [3, 4]. BDS' systems apparently work by computing very slow, very broadband time-frequency (TF) representations of the standard and target signals. For example, in [4], the use of a 32-cell TF representation that represents 64 sec of sound as a 4-by-8 matrix is described, meaning four frequency bands and eight blocks of time.

Such a representation—with an envelope sampling rate of ⅛ Hz—is obviously far from the highly accurate, invertible TF representations typically used in music analysis/synthesis applications (see [5]), but it suffices for the purposes of comparing two signals in BDS' application.

These representations can be compared using a Euclidean distance metric (typically 0-norm or 2-norm) directly on the TF data unwrapped into vectors. An important application requirement for BDS' method was invariance of the comparisons under speed change (that is, playing the music slightly faster or slower than normal), since broadcast radio programmers vary playback speed—anecdotally, as much as +/−3%—in order to make a song fit a desired timeslot. This happens naturally in BDS' method because the resolution is so coarse; even unusually vigorous speed change has little impact on which bits of the signal are assigned to which bins.

A few systems for performing audio fingerprinting have been recently reported in the technical literature. Haitsma et al [6] presented a system that computes the energy in 32 log-spaced frequency bands and computes the 2-dimensional difference function on the resulting TF representation for use as a fingerprint. They report excellent resilience to simple signal modifications on 3-sec long fingerprints, including MP3 encoding/decoding, dynamic range compression, and equalization, and present an efficient method according to the present invention for locating fingerprints in a database of music.

Allemanche and his collaborators at FhG [7-9] describe experiments using features including band-by-band loudness, spectral flatness, and spectral “crest” to match pieces of audio. They use vector quantization-based retrieval to accelerate the search process. At least in their published work to date, they have examined performance only in relatively easy conditions—high bitrate MP3 encode/decode, noise at high SNR, and A/D D/A signal chains, with lengthy (20 sec) fingerprints.

A paper by Fragoulis et al [10] describes a method for automatically recognizing musical recordings. They collect the positions of the most prominent spectral peaks in the signal under a variety of spectral shifts (to cope with the speed change) and use them to create characteristic vectors for the signals. These fingerprints are large compared to those used in the three abovementioned systems. They tested their system on 920 pieces of music received over FM radio broadcast, reporting 94% accuracy in matching the broadcast signals to the canonical versions in a database with 458 samples Unfortunately, the computation time for their method is prohibitive for real applications—42 computer minutes (500 MHz Pentium III) per minute of sound to create the template database, and an average of 3.5 computer minutes to match one 12-second fingerprint against this database. Their search method is linear in the size of the database, so many hours of search would be required for large template sets.

A common restriction of all of these above-mentioned systems is that they are intended to deal primarily with what will herein be termed featured music—namely, music which is “in the foreground” of a particular audio presentation, with as little occluding noise, dialogue, etc as possible. It is apparent from studying the operation of these method according to the present invention s that when interfering sounds are mixed in, the performance can no longer be guaranteed. For example, in the BDS case, since the coarse TF representation essentially captures the slowest frequency components of the envelopes in four signal bands, a mixing signal may well change the envelopes and thereby obscure the fingerprint.

There are many applications in which it is desirable to detect music in the presence of interfering sounds. For example, one might consider the goal of television broadcast monitoring—detecting whether or not a particular piece of music is being used in the background of a television broadcast, where detection would have to be robust to the interference provided by dialogue, sound effects, laugh tracks, and so forth. Another application would be cell-phone based identification of environmental music, where a user at a nightclub dials into a database that can identify and remember a song playing in the environs despite (1) the heavy artifacts that arise when music is passed through a narrowband CELP coder such as GSM, and (2) the ambient noise created by other patrons in the locale.

Typically, audio watermarking (XXX) is the technology solution considered for such applications. However, watermarking has numerous well-known disadvantages in many practical circumstances, especially the fast that legacy content (that is, content not watermarked) cannot be recognized, and that watermarks are vulnerable to attack that strips the mark without impairing audio quality (See reference below by Felton, of Princeton University).

See [11] for a thoughtful review of the suitability of audio fingerprinting and watermarking to a number of of applications. It is the goal of the present work to bring the accuracy which watermarking has been used.

This paper will present a method for identifying musical samples in the presence of such artifacts in the face of a range of impairments, and the difficult problem of and interfering signals. Both the concept and the detailed implementation of the method according to the present invention will be described, a series of evaluation tests will demonstrate the system's performance quickly searching large databases for matches with errors will be discussed.

1. In-Band Frequency Estimation in the Presence of Interfering Signals

The basic novelty of the present system comes from its use of in-band frequency estimates to augment in-band level estimates as the underlying features. In this section, a brief theoretical presentation will explain why this is a good idea. For another perspective with similar approach, see Chapter 5 of [12], which explores a related processing model in the context of explaining human source-segregation ability.

Most of the previous systems described in the foregoing operate by extracting dynamic signal information from template sounds and then comparing the analogous dynamic information in a target sound to the templates. That is, these techniques are based on the principle of analyzing the changes in sounds rather than their static properties. (This makes sense psychoacoustically, as the human auditory system is most sensitive to changes in the acoustic environment and quickly adapts to any stationary “background” sound).

For the purposes of achieving robust fingerprinting, it is desirable, then, for the extracted dynamic information to be as robust as possible to signal impairments. While [INSERT]-based features are robust in some circumstances, frequency-based features are generally more robust, and robust to a broader range of impairments. In this section, this claim will be verified through two experiments. The first examines the robustness of parameter extraction for tones interfering with other tones, and the second examines the robustness when noises are the interfering signals.

1.1. Tone Plus Noise Analysis

Perhaps the simplest sort of signal that undergoes the dynamic changes extracted by fingerprinting method according to the present invention s is a modulated tone. In this section, the extraction of dynamic frequency and power parameters from tones undergoing amplitude and frequency modulation, in the presence of interfering modulated tones, will be explored.

Let the test signal x[t] be a discrete AM-FM tone with noise interference, that is:
x[t]=s[t]+n[t]
s[t]=sin[D sin(2πtM+φ₁)+2πtF₀+φ₂][1+A sin(2πtR+φ₃)] (1)
where:ohooooo

0<t<T, where T is the length of the signal,

D is the frequency modulation index,

M is the frequency modulation rate,

F₀ is the carrier frequency,

A is the amplitude modulation depth,

R is the amplitude modulation rate,

n[t] is a uniform random noise signal,

and φ₁, φ₂, φ₃ are random starting-phase parameters.

The goal of parameter extraction is to estimate the instantaneous frequency and power functions F[t] and P[t] for s[t] given the test signal x[t], and without corruption from the interfering signal n[t]. In particular, with fingerprinting techniques like those described below and Haitsma et al (XXX), it is desirable that, regardless of the particular n[t] added as interference, the sign (rising or falling) of the delta frequency and delta amplitude be invariant.

To assess the effects of noisy interference signals on the robustness of parameter extraction, an experiment was conducted. On each of several randomized trials, a test signal was generated, with n[t] a broadband white noise. The signal was passed through an half-octave bandpass window centered near (but not exactly at) F₀. Windowed autocorrelation and windowed RMS (for exact details, see section 3) were used to compute the estimates of F[t] and P[t]. Then, the following error functions were computed:

$${E}_{F} = \frac{1}{T} {\sum }_{t = 1}^{T} \{ \begin{matrix}1 \text{:} if sgn ( F [ t ] - F [ t - 1 ] ) \neq sgn ( \hat{F} [ t ] - \hat{F} [ t - 1 ] ) \\ 0 \text{:} otherwise\end{matrix} \\ {E}_{P} = \frac{1}{T} {\sum }_{t = 1}^{T} \{ \begin{matrix}1 \text{:} if sgn ( P [ t ] - P [ t - 1 ] ) \neq sgn ( \hat{P} [ t ] - \hat{P} [ t - 1 ] ) \\ 0 \text{:} otherwise\end{matrix} \qquad ( 2 )$$

where \hat{F}[t] and \hat{P}[t] are the instantaneous frequency and power estimates from s[t], the uncorrupted signal. More than 2000 trials were run, with parameters randomly ranging as shown in Table 1.

TABLE 1
Parameter Ranges for Tone-in-Noise Experiment

| Parameter | Meaning | Range |
|---|---|---|
| D | FM index | 1-5 |
| M | FM rate | 1-10 Hz |
| A | AM depth | 2-20% |
| R | AM rate | 1-10 Hz |
| F₀ | Carrier frequency | 300-400 Hz |
| F_{c} | Center frequency of bandpass | 300-400 Hz |
| N | Noise power level | −20 dB-20 dB |
| | (relative to signal power) | |
| Φ₁, Φ₂, Φ₃ | Phase offsets | 0-2π |

Results are shown in FIG. 1. The frequency estimate is a more robust parameter, in the sense of being less corrupted by noise, than the power estimate. This is true at all SNR levels; the frequency estimate error is 10% lower than the power estimate error at low SNR, and 80% lower at high SNR. Put another way, the frequency estimate is as robust at −5 dB SNR as the power estimate at +5 dB SNR.

[image]

FIG. 1: Effect of Interference Noise Level on Accuracy of Parameter Estimation.

Each data point represents the mean error over several trials near that SNR level; in total, 2000 trials are represented in the figure. The error rate is measured by estimating the changes in instantaneous frequency and power from AM-FM sinusoid in the presence of noise, and comparing the estimates to those derived from the same sinusoid without noise. The frequency estimate is a more robust parameter, in the sense of being less corrupted by noise, than the power estimate—error rates are 10% lower at low SNR and 70-80% lower at high SNR.

1.2. Tone Plus Tone Analysis

The analysis in the preceding section showed that in-band frequency estimates are more robust than power in-band estimates to the presence of interfering white noise. However, in real applications, the interference signal is not always white noise. In particular, in the case of soundtrack monitoring, there will often be tonal signals, particularly the speaking voice, interfering with the music to be recognized. Therefore, a parallel experiment was conducted in which the interference signal was another AM-FM tone.

In this case, the test signal x[t] takes the form
x[t]=s[t]+n[t]
s[t]=sin[D sin(2πtM+φ₁)+2πtF₀+φ₂][1+A sin(2πtR+φ₃)]
n[t]=N sin[D_{N} sin(2πtM_{N}+φ₄)+2πtF₀_{_{N}}φ₅][1+A_{N} sin(2πtR_{N}+φ₆)] (3)
where D_{N}, M_{N}, F_{0N}, A_{N}, and R_{N} are the parameters of the interfering signal n[t], and φ₄, φ₅, φ₆ are its random starting-phases.

The signal processing conducted in this case was the same as in the noise experiment, with E_{F} and E_{P} defined as in (2). Parameters for the signal parameters and the analogous interfering-tone parameters were set randomly as shown in Table 1. The accumulated results over 1000 trials are shown in FIG. 2.

From examining FIG. 2, it is clear that this is a more difficult test than the noise interference test. At very low signal-to-interference levels, where the interfering tone is much more intense than the signal tone, performance is near chance level (50% error rate). This makes sense, because at such interference levels, the properties of the interfering tone are the ones really being measured by the estimation procedure, not those of the signal tone. Nonetheless, the frequency estimates are still at least as robust to tonal interference, at all signal-to-interference levels, as are the power estimates.

[image]

FIG. 2: Effect of Interfering Tone Level on Accuracy of Parameter Estimation.

Each data point represents the mean of several trials at that signal-to-interference level; in total, 1600 trials are represented in the figure. The error rate is measured by estimating the changes in instantaneous frequency and power from AM-FM sinusoid in the presence of an interfering AM-FM sinusoid, and comparing the estimates to those derived from the same sinusoid without interference. The frequency estimate is a more robust parameter, in the sense of being less corrupted by the interfering sound, than the power estimate—error rates are 0-5% lower at low signal-to-interference and 20-40% lower at high signal-to-interference.

Based on these results, it seems clear that a frequency-change-based fingerprinting system should perform better than a strictly amplitude-change based one. It is possible to arrive at many other features that could be tested in a framework like this. However, stochastic theory teaches that if multiple measures are independently distributed, it isn't possible to reduce the error rate by creating new features as linear combinations of simpler ones. For example, Haitsma et al. (XXX) use an level-based feature created by taking the difference of the delta amplitude (related to the ΔP shown here) in neighboring frequency channels. If the measurements in the frequency channels are independent, this gives no advantage in estimation in noise to simply using both channel measurements themselves. In practice, when the Haitsma features were tested within the experimental framework shown here, they performed no better than the power features.

An even better solution, and the one adopted for the fingerprinting system described below, is to use both level-based features and in-band-frequency—based features. This is a good idea for two reasons.

First, there are portions of musical signals that have no tonal components (for example, in drum breaks) in which estimation of fundamental frequency is meaningless. Level-based features must be used on such segments. Second, there are tradeoffs in estimation error between level-based and frequency-based features depending on the interference characteristics. An example is shown in FIG. 3, in which the data from the above two experiments are plotted as a function of the distance between the signal F0 (carrier frequency) and the center frequency of the bandpass filter. Particularly with tonal interference, the frequency estimates degrade as the signal moves outside of the filterband. Thus, for best overall performance, it is desirable to include the level-based features that do not show this degradation.

[image]

FIG. 3: Tradeoffs between Power Estimates and Frequency Estimates.

The data shown are the same as those plotted in FIGS. 1 and 2. Here, they are averaged across all signal levels and grouped by the absolute difference in Hz between the signal F0 (carrier frequency of the AM-FM signal tone) and the center frequency of the ½ octave bandpass filter. Particularly in the case of tonal interference, the robustness of frequency estimates degrades more rapidly than does that of the power estimates as the signal becomes far off-center from the filter.

2. Fingerprint Extraction

In this section, the operation of the fingerprint extraction method according to the present invention is described. A summary block diagram is provided in FIG. 4. In brief, the method according to the present invention is decomposed into a time-frequency representation with a log-spaced 16-band filterbank. Then, from each band, the change in fundamental frequency (ΔFF) and power (ΔP) are estimated 50 times per second. The ΔFF and ΔP signals are quantized to 1 bit each, resulting in a 32-bit pattern (one FF bit and one P bit for each of 16 channels) for each time frame. The resulting sequence of 32-bit integers is the fingerprint for the audio pattern.

[image]

FIG. 4. Outline of Method According to the Present Invention.

The input signal x[t] is decomposed into 16 bandpass signals yᵢ[t]by passing it through a filterbank. For each filter channel in each frame, detection of change in fundamental frequency (ΔFF) and power (ΔP) is conducted and the results passed through a 1-bit quantizer. The 32 1-bit signals output from the quantizers are packed together to form a single 32-bit integer, which is the fingerprint FP for that frame. Note that there is an implied decimation step in the computation of ΔFF and ΔP.

2.1. Frequency Decomposition

In the present implementation of the method according to the present invention, an incoming sound signal is digitized and/or converted into a monophonic, 8000 Hz sampled, 16 bit audio sequence. A filterbank composed of logarithmically-spaced 5th-order Chebyshev bandpass filters is used to decompose the signal into a 16-band representation.

The frequency response of this filterbank is shown in FIG. 5. Let x[t] denote the original acoustic musical signal with length N samples; then the output of the filterbank is
yᵢ[t]=x*Hᵢ, 0<i<16, 0<t<N (4)
where the * denotes convolution with Hᵢ, the i-th filter in the filterbank.

From the continuing description below, it should be clear that many other filterbanks would suffice in this method according to the present invention, including some with significantly lower computational cost.

The filterbank and audio signal are currently downsampled for processing to a sampling rate of SR=8000 Hz, but it should be clear that running the processing at some other rate would suffice as well.

[image]

FIG. 5. Filterbank used for signal decomposition.

Each of the sixteen bands is a fifth-order Chebyshev filter. Center frequencies are spaced logarithmically between 150 and 2500 Hz.

2.2. Computation of ΔP

From each filter channel yᵢ, the RMS power of the channel is estimated in each frame. Every F=0.02 sec, the signal is windowed by convolution with a L=250 ms Hamming window. This creates signal frames numbered k=0, 1, 2, . . . M=N/F·SR. Denote the windowed version of yᵢ [ ] as ŷᵢ[ ].

The values of L and F were chosen empirically to balance three goals: (1) capturing the dynamic changes in the audio signal, (2) preserving smooth frame-to-frame transitions in the extracted features, and (3) minimizing the computational load. It is likely that other combinations of frame rate and smoothing window length would suffice as well.

Within each frame with start time t=kF, the power in channel i, Pᵢ[k],is computed as:

$${P}_{i} [ k ] = \sqrt{\frac{{\sum }_{0 < t < L \cdot SR} {{\hat{y}}_{i} [ kF + t ]}^{2}}{L \cdot SR}} , 0 < k < M = N / SR // \qquad ( 5 )$$

The change in power in channel i, ΔPᵢ[k] is simply computed as the change in power, scaled as a ratio:
ΔPᵢ[k]=(Pᵢ[k]−Pᵢ[k−1])/Pᵢ[k], k=1, 2, 3, . . . M (6)
It should be apparent that other methods of computing the change in power in a channel, for example by measuring the derivative of the envelope, would suffice as well for this computation.
2.3. Computation of ΔFF

From each filter channel yᵢ, the fundamental frequency of the channel is estimated in each frame, synchronous with the power estimation detailed above, if the power in the channel is significant (for channels with little sound energy—herein, meaning more than 60 dB below maximum energy—the fundamental frequency is not meaningful and the frequency estimate is simply taken at the center frequency of the channel).

Within each frame for each filter channel (denote this frame's start time as t=kF), the autocorrelation of the filter output is computed:

$${R}_{yy} [ i , k , τ ] = {\sum }_{t = 0}^{L \cdot SR} {\hat{y}}_{i} [ kF + t ] {\hat{y}}_{i} [ kF + t + τ ] , 0 < τ < L \cdot SR \qquad ( 7 )$$

R_{yy}[i, k, τ] here represents the autocorrelation of filter channel i in block k at lag τ. In the present implementation, the autocorrelation is calculated by use of the Fast Fourier Transform (FFT) implementation of the Discrete Fourier Transform (DFT), using the well-known relationship between the DFT and the autocorrelation. Other methods of computing the autocorrelation would suffice as well, although they might be less efficient computationally.

Within each filter-channel autocorrelation R_{yy}[i, k, τ], the lag of the first peak point corresponds to the period of the fundamental frequency of the filter channel (see FIG. 6).

[image]

FIG. 6: Autocorrelation for Fundamental Frequency.

Within each block and filter channel, the autocorrelation is used to estimate the fundamental frequency. Because of the bandlimited nature of the filtered signals, peak-picking from the autocorrelation robustly reflects the frequency in each band.

The peak point is computed by quadratic interpolation around an initial candidate peak point. The candidate peak is computed by locating the smallest point T in R_{yy}[i, k, τ] such that:
R_{yy}[i, k, T−1]<R_{yy}[i, k, T]>R_{yy}[i, k, T+1] (8)
Then, the values of R_{yy}[i, k, τ] around T are interpolated quadratically, using the following method (see FIG. 7) to arrive at pᵢ[k], the period in frame k in channel i:
Let y₁=R_{yy}[i, k, T−1]
   y₂=R_{yy}[i, k, T]
   y_{3=R}_{yy}[i, k, T+1]
   a=0.5(y₁+y₃)−y₂
and b=−2aT+a+y₂−y₁,
Then define pᵢ[k]=−b/2/a.

It will be apparent to the reader that this is simply a closed-form solution to the general quadratic interpolation method given the constraints that apply in this particular case.

This procedure is necessary because audio sampling rates do not give enough resolution for accurate pitch-change measurements. For example, consider the 6th band, with CF=360 Hz. In this band, at SR=8000 Hz, a peak lag of 23 sample points corresponds to a FF of 347.8 Hz. The next lag point, at 43 sample points, corresponds to a FF of 363.6 Hz, nearly a full semitone higher. Thus, simply using the raw peak lags would mean that make no pitch distinctions finer a semitone could be made in this band. This, in turn, would mean losing subtle inflections in voice and instrument onsets that, empirically, prove crucial for best fingerprint-matching performance.

It would be possible, of course, to run the audio method according to the present invention s at 48 KHz or even 96 KHz to ameliorate this problem somewhat, but at these sampling rates the computational costs of filtering and autocorrelation become prohibitive. Quadratic interpolation is a more cost-effective solution.

[image]

FIG. 7: Quadratic Interpolation of Peaks.

Because the audio sampling rate is too low accurately estimate pitch directly from peak-picking in the autocorrelation, quadratic interpolation is performed to increase the effective resolution. Highlighted points are the values of R_{yy}[i, k, τ] around τ=T, which is the local maximum of the first peak in the autocorrelation function as shown in FIG. 6. A parabola (quadratic equation) is fitted (dark curve) to the left neighbor, local maximum, and right neighbor, and the peak of this parabola is selected and used to compute the actual pitch estimate (dark line).

The change in fundamental frequency ΔFFᵢ[t] is simply calculated as the frame-to-frame difference in frequency frequency (which is the reciprocal of the period measured in seconds), scaled as a ratio:

$$Δ {FF}_{i} [ k ] = \frac{\frac{SR}{{p}_{i} [ k ]} - \frac{SR}{{p}_{i} [ k - 1 ]}}{\frac{SR}{{p}_{i} [ k ]}} , k = 1 , 2 , 3 , … , M \qquad ( 9 )$$

It will be apparent that other methods of extracting the change in fundamental frequency in a channel, for example by counting zero-crossings or computing the FFT, would work as well.

2.4. Fingerprint Packing

For each frame k the ΔFF and ΔP values are bit-packed into a 32-bit integer. First, each channel's ΔFF and ΔP values are quantized to 1-bit PCM. Then the resulting 1-bit signals are used to create a sequence of 32-bit values.

Given the ΔFF and ΔP values as computed above, we use frequency and power thresholds f and p to compute:
b₂ᵢ[k]=1 if ΔFFᵢ[k]>f, otherwise 0, 0<i<16
b₂ᵢ₊₁[k]=1 iff ΔPᵢ[k]>p, otherwise 0, 0<i<16 (10)

In the present implementation, f=p=0.001.

Then, the fingerprint value in block k, F[k], is computed as:
F[k]=Σᵢbᵢ[k]2ⁱ, 0<i<32 (11)
The F[k] sequence therefore consists of one 32-bit integer for each frame of time, or 50 integers (totalling 200 bytes of storage) for each second of sound when F=50 Hz. The F[k] sequence is termed the fingerprint of the audio sequence x[t].

This fingerprint size is in the middle range of others reported in the literature. The method of Haitsma et al results in a fingerprint that is 60% larger (one 32-bit integer per frame at 80 Hz frame rate). Allamanche and collaborators [9] have explored the effect of using extremely small fingerprints in their system; they do not begin to show significant degradation against their baseline results until their fingerprints are only 4% as big as the ones reported here (4 bits per frame at 33 Hz frame rate).

3. Fingerprint Matching

In the present system, fingerprint matching is done very simply, by computing the Hamming (bit-error) distance between a fingerprint and a test sample. This matching method proves empirically to work very well (see Section 5). In this section, the basic segment-matching operation will be discussed, and then a short extension into soundtrack analysis will be presented. Thoughts on more elaborate matching methods and efficiency improvements conclude.

3.1. Segment Matching

The most basic form of matching is simply to compare two fingerprints to determine whether they contain the same audio material. Assume two fingerprints, F₁[i], 0<i<N, and F₂[j], 0<j<M, and assume without loss of generality that N≦M (otherwise, just reverse the labels of the two fingerprints).

For a single frame of fingerprint data from each of F₁ and F₂, define the frame similarity as the proportion of bits that share the same value (that is, unity minus the Hamming distance scaled by the length of the vector). Define:

$$FS ( {F}_{1} [ l ] , {F}_{2} [ j ] ) = \frac{1}{32} {\sum }_{k = 0}^{31} \{ \begin{matrix}1 \text{:} if bit k of {F}_{1} [ i ] = bit k of {F}_{2} [ j ] \\ 0 \text{:} otherwise\end{matrix} \qquad ( 12 )$$

There are a variety of well-known methods for computing this function in sublinear time in the number of bits through the use of judicious bit-twiddling.

Several aspects of this comparison will be noted. First, this method of comparison weights the pitch-change and amplitude-change aspects equally. Second, this method of comparison weights all parts of the spectrum equally. Third, this method of comparison treats each filter channel independently—not considering, for example, whether the bits that are equal in the two frames are next to each other or spread out across the spectrum. As can be seen from the performance tests below, the method empirically performs well given these restrictions. However, it is entirely possible that better performance could be achieved with some other bitwise FS(·) function. This is left as a topic for future work.

To compare the full fingerprints F₁ and F₂, each possible starting lag k for F₁ within F₂ is examined and compute the mean frame similarity s[k] at this lag is computed. This is done by matching each frame in F₁ against the corresponding one in F₂ (see FIG. 8). Given a starting lag k, 0<k<M-N, compute:
s[k]=1/(M−N) ΣᵢFS(F₁[i], F₂[i+r]), 0<i<N (13)

[image]

FIG. 8: Fingerprint Comparison.

Comparing two segments of music F₁ and F₂ is accomplished by averaging the frame similarity across the segments, for each lag overlap between the two.

Then the fingerprint similarity between F₁ and F₂ is simply the maximum of s[k] over all the lags; that is,
c(F₁, F₂)=maxₖs[k]. (14)

In order to select the best match out of a database of templates, the fingerprint similarity is computed between the target F₁ and each candidate template F₂ ε{T₁, T₂, . . . , T_{D}} where D is the number of templates in the database. It may be desirable, depending on the application, to reject the target as unknown (to minimize the number of false positives, for example) if the best match is below a certain threshold α, or to use a more efficient method for finding the best match than brute-force search through the database. These topics are discussed in Section 3.3 and 4.1, respectively.

3.2. Soundtrack Matching

A more realistic scenario for deployment of music fingerprinting method according to the present invention s is monitoring soundtracks or other lengthy audio samples for music. In such an case, it is desirable to take advantage of the application-level constraints that apply. These might include:
1. It is unlikely that a particular piece of music will appear for a very short amount of time—half a second, for example.
2. If the same piece of music is found at two successive moments in time, these moments should be contiguous in the template for the music.
3. The most common pattern in a soundtrack is for a sample from one piece of music to occur, then no music for a while, then a sample from another, then no music, and so on.
   (It is to be emphasized that these are only example constraints for one application, and other applications will likely bear different constraints).

The basic commonality among all of these constraints is that they express ways in which the frames of time are not independent from one another—rather, the most-likely result for frame k should depend heavily on what's going on in neighboring frames. Such constraints can be formalized and implemented by use of a Markov lattice for soundtrack analysis (see FIG. 4). In such a model, the soundtrack is modeled as a path through a sequence of states—for each block of time, the path passes through the state corresponding to the particular musical excerpt playing at the time. By associating a cost with each state according to the output from the frame-by-frame analysis, and with each transition from one state to another, the overall soundtrack analysis problem becomes one of optimizing the path through the model.

[image]

FIG. 9: Markov Lattice for Soundtrack Processing.

At each block k, the states s_{i k} correspond to the assertion “musical excerpt # i is present in block # k.” The states nₖ correspond to the assertion “there is no music in frame # k.” A cost is associated with each state according to the output of the frame-by-frame analysis, and with each transition according to application-specific prior knowledge (see text for details). The lattice is fully connected from one frame to the next; in the diagram, most of the transitions have been grayed out for clarity. Finding an optimal soundtrack means choosing a sequence of statements and transitions σ₁τ₁σ₂τ₂σ₃τ₃ . . . that minimizes the total cost. This can be done with the Viterbi method according to the present invention.

To compute the most-likely soundtrack for a given audio sequence, first, the audio is divided into blocks. The block size and overlap between blocks determine the granularity of soundtrack analysis, as well as the accuracy and speed of processing. To obtain the soundtrack-analysis results shown in Section 5, one-second blocks were used for analysis. For each block, the audio fingerprint is computed and the quality of match is computed to each fingerprint in the database.

The quality-of-match results are used to assign costs to states and transitions. Referring to FIG. 9, the states labeled nₖ receive the cost associated with deciding that there is no music in a particular block. Typically, this cost is set proportional to the best match of any piece of music in the block—so that if a piece of music matches well, it is expensive to decide that there is no music. The states labeled sᵢₖ, where i<N, the number of templates in the music database, receive the cost associated with deciding that there is a particular piece of music playing in a particular frame. This cost is set so that it is expensive to occupy the state sᵢₖ if music template i is not a good match in block k.

There are five kinds of transitions. The transitions labeled t₁ represent the cost associated with staying in the “no music” state from one frame to the next. The transitions labeled t₂ represent the cost associated with starting a music segment. The transitions labeled t₃ represent the cost of ending a segment of music. The transitions labeled t₄ represent the cost of staying in the same piece of music from one state to another. And the transitions labeled t₅ represent the cost of jumping from one piece of music to another. The appropriate values of these transitions are application dependent, as they embed domain-specific constraints such as the likelihood of music playing or not playing.

Then, given the states nₖ and sᵢₖ and the transition arcs t₁ . . . t₅, let |nₖ|, |sᵢₖ|, and |tⱼ| denote their costs. We wish to find the optimum path P through the T blocks of time:
P=σ₁τ₁σ₂τ₂σ₃τ₃ . . . σ_{T}
σₖε{nₖ, s₁ₖ, s₁ₖ, . . . s_{Nk}}; τₖε{t₁ . . . t₅} (15)
This path is just the one that minimizes

$$\vert P \vert = ( {\sum }_{k = 1}^{T - 1} \vert {σ}_{k} \vert + \vert {τ}_{k} \vert ) + \vert {o}_{T} \vert \qquad ( 16 )$$

There are far too many possible sequences P to examine them all. Consider a ten-minute soundtrack matched against a small database of 1,000 songs. This soundtrack has T=10×60=600 blocks. In each time step, there is one state for each of the songs, plus one for the no-music state. There are thus 1,001⁶⁰⁰ sequences, or more than 10¹⁸⁰⁰. Fortunately, the well-known Viterbi method according to the present invention (XXX) allows the optimal sequence to be computed in time proportional to T×N², a more reasonable demand.

The optimal sequence P can be easily interpreted as a musical cue sheet—that is to say, by examining P, it can be determined that from time k=4 through k=12, template #24 is present. Then there is no music until k=26, at which point template #634 begins playing and plays through the end of the signal.

3.3. Optimized Database Search

The method presented for fingerprint comparison in Section 3.1 is brute-force in nature. For large databases, it is very expensive to compare a target segment of sound to each frame of each known fingerprint. For example, consider a database of 100,000 songs, each four minutes long, and a 2-sec target that must be matched. There are a total of 100 000×4 min/song×60 sec/minute×50 frame/sec=1.2 billion candidate starting positions. Each comparison requires on the order of 50 multiply-adds per second of target sound, and so on the order of 100 billion multiply-adds must be computed for the brute-force method according to the present invention. Clearly this is infeasible for a large database.

The optimization improvement suggested by Haitsma et al [6] is to reorder the fingerprint database so that it can be efficiently searched. Their observation is that, under their test conditions, there are typically one or more frames in the target sound that exactly match the analogous frame in the template fingerprint. Using their estimate of BER=11.5% bit error rate, and assuming the bit errors are evenly distributed over their 32-bit sample frame, this is true for 1-[1-(1-BER)³²]²⁵⁶=99 44/100% of their 256-frame targets (quite a pure result). They consider each of the frames in the target fingerprint, and look it up in the index to see if it occurs in any of the templates. If it does, the full template is compared at that point to see if the match is an actual one, or a spurious one.

However, this method does not suffice for the present problem. This is because the deployment conditions (mixing with interfering signals) contemplated here are more difficult than those examined by Haitsma et al. In practice, the brute-force method can successfully detect fingerprints in which the bit-error rate is as high as 40% (see Section 5). In such a circumstance, for a two-second target containing 100 frames, only in 1 out of 8×10⁶ cases are there any exact frame-to-frame matches.

There are a number of method according to the present invention s in the computer-science literature that could be brought to bear on the problem. The problem of matching fingerprints to templates with a given BER can be viewed in two ways. First, it might be considered a sort of approximate string matching, where the target fingerprint is taken as a substring that must be located within a longer string—one of the templates—with a certain number of errors allowed. Due to the interest in string-matching method according to the present invention s in the field of bioinformatics, there has been a great deal of work applied to these sorts of problems recently; [13] contains a review and summary.

Apparently, the best performing method according to the present invention s today provide a boost to efficiency only when the number of errors in the string is very much smaller than the length of the string—this is not the case here. Further, any improved method of string searching will still scale only linearly in the size of the template database. That is, if the size of the template database doubles, the number of comparisons doubles as well.

More promising are a second group of techniques, in which the fingerprint of the target and each of the templates are considered to be vectors in a high-dimensional space. That is, a fingerprint of one second of sound is a vector in the space [0,1]¹⁶⁰⁰ (the 1600 dimensions are the 32 bits per frame for 50 frames per second). Each candidate starting position for each template is a vector in the same space. Then, for a given target vector, the template candidate that is closest to the target is located, where the distance metric used is the Hamming distance.

Problems of this sort are well known to suffer from the so-called curse of dimensionality—namely, as the number of dimensions gets large, it becomes more and more difficult to prune the search space effectively so as to avoid linear search of the database. Gionis et al [14] discuss techniques for approximate nearest neighbor, in which probabilistic bounds govern the frequency of cases in which the actual nearest neighbor is returned, rather than some other candidate. (In principle, a small proportion of incorrect matches would not harm the soundtrack analysis process, as the Viterbi processing would smooth them out.) In fact, Gionis et al.[14] conduct their analysis for binary [0/1] vectors like the ones used herein, then use a mathematical transformation to show that their results apply more generally. Their technique involves repeatedly sampling a subset of dimensions and using the results as a hash index into the overall space. Unfortunately, while this method would work very well with lower BER, it is possible to show mathematically (although the analysis is outside the scope of this presentation) that it does not work well when BER>25% or so, and especially when the “near misses” are somewhat close to the nearest neighbors.

A compromise method according to the present invention lies in between the method of Haitsma et al [6] and the brute-force technique; it will be presented here. As in their technique, the template database is indexed to provide quick lookup. But rather than restrict searching to the case in which there is an exact match, the search is conducted to find any candidate frame that has fewer than k errors compared to a frame of the target.

That is, consider a particular frame F of the target fingerprint. This frame is a sequence of 32 bits, b₀b₁b₂ . . . b₃₂. There is exactly one way in which a template frame might match this with no errors; namely, if the template frame F_{T} is the same sequence as F. There are 32 ways in which a template frame matches the target frame with one error, namely if
F_{T}δ{\overline{b}₀b₁b₂ . . . b₃₂,b₀\overline{b}₁b₂ . . . b₃₂, . . . , b₀b₁b₂ . . . \overline{b}₃₂} (17)
where the overbar indicates a bit error. There are 496 possible two-error matches, and more generally

$$C ( \begin{matrix}32 \\ k\end{matrix} ) = \frac{32 !}{k ! ( 32 - k ) !} \qquad ( 18 )$$

possibilities that have k errors.

The exact process works as follows (see FIG. 10). The entire set of frames of template fingerprints is considered to be a single large database—so if there are 100,000 pieces of music averaging 4 minutes apiece, there are 1.2 million frames in the database.

[image]

FIG. 10: Efficiently Searching Template Database for Imperfect Matches.

At left, in an offline preprocessing stage, all the frames from the set of template fingerprints are sorted into order. Each

First, offline, the database of frames is sorted into order. The exact metric for order is irrelevant; one convenient way is to treat the 32-bit frame value as an integer and sort on numerical value. Each frame is associated with two pieces of data: (1) the identifier of the template from which it came, and (2) the frame's offset within the template (thus, the index is larger by a factor of three than the fingerprint database itself).

To match a target fingerprint, each of its frames is examined to see if any of them is exactly in the index. If they are, a brute-force comparison between the target fingerprint and to the associated template at the associated offset is conducted, in order to see if this block indeed matches the fingerprint. If not, for each frame, each of the 32 one-error versions is examined, by flipping first bit 0 of the frame, then bit 1, and so on, and see if any of these one-error matches are in the index. If not, matching proceeds to the two-error versions, the three-error versions, and so forth. If, after checking all of k-error matches, where k is a predefined maximum error depth for the search, the fingerprint has not be found, then we assume it is not present in the database.

This technique provides two key efficiency improvements over the brute-force method. First, the whole database is not searched, but instead only a small subset. Second, because the index lookup can be done with binary search techniques, the search time scales logarithmically with the size of the template database, rather than linearly. Further improvements in search efficiency can be achieved by using a hybrid hashing-binary search technique. For example, the index of all 32-bit frames can be hashed into 4096 groups according to the first 12 bits. Then, for a particular corrupted version of a particular frame, only the proper hash group need be searched at all.

Like the approximate nearest-neighbor method of [14], this method is probabilistic. That is, it is not guaranteed that if a match is in the database, it will be found. (If the error depth is k, and the best single-matched frame between the template and the target has more than k bit errors, then the match will be missed). The probability of actually locating a match that is in the database is dependent on the BER, the length of the fingerprints considered, and the error depth k to which we search. Table 2 shows the probability of finding a match according to the BER and the error depth for one-second and two-second fingerprints. The values shown were calculated with a Monte Carlo simulation and are approximate.

TABLE 2
Cumulative Probability of Finding Match^{a}

| Maximum | BER = 80% | | BER = 70% | | BER = 60% | | Total # of | |
|---|---|---|---|---|---|---|---|---|
| number | One- | Two- | One- | Two- | One- | Two- | index | P [false |
| of | sec | sec | sec | sec | sec | sec | lookups | candidate] |
| errors | block | block | block | block | block | block | (2 s) | (2 s) |
| 0 | 4% | 8% | 0.05% | 0.6% | 0% | 0% | 100 | 0 |
| 1 | 31% | 51% | 0.7% | 1.5% | 0% | 0.02% | 3,300 | 0 |
| 2 | 80% | 96% | 5% | 11% | 0.08% | 0.1% | 52,900 | 0 |
| 3 | 99.4% | 100% | 23% | 42% | 0.8% | 1.2% | 548,900 | 4 |
| 4 | 100% | | 60% | 85% | 3.5% | 7% | 4,144,900 | 24 |
| 5 | | | 92% | 99.6% | 13% | 24% | 24,282,500 | 307 |
| 6 | | | 99.8% | 100% | 37% | 60% | 114,901,700 | 3740 |
| 7 | | | 100% | | 72% | 92% | 451,487,300 | 44,656 |
| 8 | | | | | 95% | 99.7% | 1,503,317,200 | 327,666 |

^{a}Values were calculated via Monte Carlo simulation and are not analytically precise.

Referring to Table 2, each cell shows the probability of finding the match, if one exists, for a given number of errors, bit error rate, and block length. For example, when all possible matches that have zero, one, or two errors in a one-second block with BER=70% are examined, there is 42% chance of finding the actual matching template among them. The second-to-rightmost column shows how many index lookups are necessary to search through this number of errors. The rightmost column shows how many candidate frames (for one-second blocks) will have the appropriate number of errors, but turn out upon full comparison not to correspond to an actual template match, assuming 50% BER for non-matching templates (XXX wrong).

The probability values in Table 2 can be used to compute the actual amount of computation required using the optimized method. For example, assume BER=60% using one-second blocks. Then to reach 95% confidence that a match will be found if it exists, the database must be searched to the depth of eight errors per fingerprint. For each frame, this requires 15 million index lookups. If there are 50 frames per second, and as before 1.2 billion candidate frames to search, these lookups will take approximately 15 million×50×log₂ 1.2 billion=27 billion compares. In addition, for each frame there are on average more than 300,000 random template frames that also have eight or fewer errors; for these we need to do a full comparison, requiring about 800 million multiply-accumulates in total.

Recall from above that a brute-force database search requires about 100 billion multiply-accumulates per frame. So, for this example, it is likely that the 95% confidence-level search will be somewhat faster than the brute force search. In addition, as the optimized search only grows logarithmically in the size of the template database, its advantage increases as the database gets larger. On the other hand, the brute force method according to the present invention may well be more efficient in this scenario for small databases. Results from actual time trials are shown in Section 5.

The optimized indexing technique can be considered a generalization of the method of Haitsma et al [6]. In the event that the BER is low, there is a high probability of finding the template as a zero-error match, and when this happens, the number of comparisons is the same as theirs. The cases where more comparisons occur here only apply in the cases wherein there were too many bit errors for the Haitsma method to find a match at all.

Interestingly, it is apparent from the mathematics underlying Table 2 that the chance of missing a match for a given error level is decreased greatly if there are fewer bits in the fingerprint. The filterbank and bit-packing scheme presented in Section 3 and evaluated in Section 5 work well with 32 bits per fingerprint, and on a block-by-frame basis the method according to the present invention would likely perform if the fingerprint were shorter. However, it might well be the case that using fewer bits in the fingerprint (either by simply eliminating channels, or by using a formal dimensionality reduction technique such as the Karhunen-Loève transform [15]) would give better results for the system as a whole when a brute-force matching technique is infeasible due to computational complexity, by allowing greater error depth to be searched.

4. Performance Evaluation

Several tests have been conducted to evaluate the performance of the audio fingerprinting system. First, an set of artificial tests was constructed in order to investigate how well the basic fingerprint-comparison process deals with a range of signal impairments. Among these artificial tests was a set of impairments created by Haitsma et al [6]. The same signals have been processed by the above-described method according to the present invention s for the purposes of comparing the new technique with theirs.

Following that, the results of short retrieval-under-impairment and soundtrack processing tests will be presented. A summary of what is known regarding the capabilities and applications of audio fingerprinting concludes the section. All tests in this section were conducted using brute-force matching.

4.1. Bit-Error-Rate Testing

The most basic test for audio fingerprinting is that proposed by Haitsma et al [6] (“HKO”): Create the fingerprint of a short excerpt of music. Then, impair the test signal somehow, and create the fingerprint for the impaired version. The Bit Error Rate (BER)—that is, the proportion of bits that differ between the fingerprints of the original and impaired signals—is the raw input for further pattern matching and processing (for example, the Viterbi method presented in Section 3.2). (Note that the BER is the same thing as the Hamming distance).

The authors of the HKO study graciously made their test materials available, so a direct comparison is possible. These test materials are an expansion of the set described in [6]. The test set was created from four audio excerpts, originally provided as stereo 44.1 kHz 16-bit WAV files: “O Fortuna” by Carl Orff, “Success has made a failure of our home” by Sinead o'Connor, “Say what you want” by Texas and “A whole lot of Rosie” by ACDC. A sample from each, approximately 3 seconds long, was excerpted. The excerpts were subjected to the following processing in order to create impaired signals [16]:
MP3 Encoding/Decoding at 128 Kbps and 32 Kbps.
Real Media Encoding/Decoding at 20 Kbps.
GSM Encoding at Full Rate with an error-free channel and a channel with a carrier to interference (C/I) ratio of 4 dB (comparable to GSM reception in a tunnel).
All-pass Filtering using the system function: H(z)=(0.81z²−1.64z+1)/(z²−1.64z+0.81).
Amplitude Compression with the following compression ratios: 8.94:1 for |A|≧−28.6 dB; 1.73:1 for −46.4 dB □ |A| □ −28.6 dB; 1:1.61 for |A|≦−46.4 dB.
Equalization with a 10-band equalizer where signals within each band are suppressed or amplified by 6 dB.
Echo addition with a time delay of 100 ms and an echo damping of 50%.
Band-pass Filtering using a second order Butterworth filter with cut-off frequencies of 100 Hz and 6000 Hz.
Time Scale Modification of +4% and −4% where the pitch remains unaffected.
Linear Speed Change of +1%, −1%, +4% and −4%. Both pitch and tempo change.
Noise Addition with uniform white noise with a maximum magnitude of 512 quantization steps.
Resampling consisting of subsequent down and up sampling to 22.05 kHz and 44.10 kHz, respectively.
D/A A/D Conversion using a commercial analog tape recorder.

For each track, the fingerprints were computed for the 3-second excerpt and each of the 19 impairments. The BER for each impairment was computed by comparing the fingerprint of the impairment to that of the original excerpt. Results of this processing are shown in Table 3. The rightmost column gives the mean of the four excerpts shown. In each cell, the left result is that reported for the HKO system and the right result (“New”) is that of the present system. The better-performing system (ie, with lower BER) for each case is shown with BER in bold.

TABLE 3
Bit Error Rates After Signal Impairment

| | Orff | Sinead | Texas | ACDC | Mean |
|---|---|---|---|---|---|
| Processing | HKO | HKO | HKO | HKO | HKO |
| MP3@128 Kbps | 0.078 | 0.086 | 0.085 | 0.084 | 0.083 |
| MP3@32 Kbps | 0.177 | 0.106 | 0.098 | 0.136 | 0.129 |
| Real@20 Kbps | 0.160 | 0.138 | 0.160 | 0.209 | 0.167 |
| GSM | 0.162 | 0.143 | 0.171 | 0.180 | 0.164 |
| GSM C/I = 4 dB | 0.286 | 0.244 | 0.316 | 0.322 | 0.292 |
| All-pass filtering | 0.019 | 0.016 | 0.017 | 0.027 | 0.020 |
| Amp. Compr. | 0.053 | 0.075 | 0.113 | 0.073 | 0.079 |
| Equalization | 0.049 | 0.044 | 0.065 | 0.062 | 0.055 |
| Echo Addition | 0.157 | 0.144 | 0.140 | 0.144 | 0.146 |
| Band Pass Filter | 0.028 | 0.026 | 0.024 | 0.038 | 0.029 |
| Time Scale +4% | 0.210 | 0.190 | 0.210 | 0.213 | 0.206 |
| Time Scale −4% | 0.217 | 0.180 | 0.199 | 0.209 | 0.201 |
| Linear Speed | 0.175 | 0.106 | 0.135 | 0.238 | 0.163 |
| Linear Speed - | 0.247 | 0.143 | 0.264 | 0.200 | 0.214 |
| Linear Speed | 0.442 | 0.464 | 0.357 | 0.472 | 0.433 |
| Linear Speed - | 0.462 | 0.442 | 0.470 | 0.433 | 0.451 |
| Noise Addition | 0.009 | 0.011 | 0.011 | 0.036 | 0.017 |
| Resampling | 0.000 | 0.000 | 0.000 | 0.000 | 0.000 |
| D/A A/D | 0.088 | 0.061 | 0.112 | 0.074 | 0.084 |

Overall (examining the “Mean” column of Table 3), the performance is very similar. The present system seems to perform better in the cases where the impairment is more critical (BER>0.1), while the HKO system performs better in the cases where the impairment is less critical (BER<0.1). This is a desirable property, if such a tradeoff be necessary, since good performance is more crucial in difficult cases. Also, the fingerprints of the present system are only 62% the size of those extracted by the HKO system, which uses a frame rate of 80 Hz.

Haitsma et al. [6] also examined the BER when comparing two unimpaired pieces of music, to show that their system could accurately discriminate between actual and spurious matches. On the six pairwise fingerprint comparisons between the four excerpts used (since matching is symmetric), they demonstrated average BER of 0.510, with standard deviation 0.026. The performance of the present system is similar: BER of 0.449, with standard deviation 0.006. Thus, in both cases, comparing fingerprints of dissimilar music results in BER that approximates chance performance¹.
¹Although the lower mean BER for differing samples for the present system might seem to indicate that the rejection of false matches would be more difficult, the smaller standard deviation makes up for it—a BER of 0.430 has a larger z-score on the different-sample distribution in the present system than in that of the HKO system (z=3.47 and z=3.08 respectively). Of course, this is based on only a very few data points.

In addition to replicating the Haitsma et al.[6] tests, a more difficult set of tests has been created in order to examine the performance of the system in extreme cases. This test was conducted using random sampling from a larger set (350 2-minute tracks) of music provided by FreePlayMusic, Inc. This set contains instrumental music from a variety of genres. The database was fingerprinted to create a set of whole-track fingerprints. Excerpts, one thousand in all, were taken by choosing random starting points within random tracks. The excerpts were manipulated in the following ways:
MP3 Encoding/Decoding at 128 Kbps and 32 Kbps.
All-pass Filtering using the system function: H(z)=(0.81z²−1.64z+1)/(z²−1.64z+0.81).
Echo addition with a time delay of 100 ms and echo damping of 50%.
Noise Addition with uniform white noise with SNR (compared to the original excerpt) of 20 dB (signal 20 dB more powerful than noise), 10 dB, 5 dB, 0 dB, −5 dB, and −10 dB (noise 10 dB more powerful than signal).
Linear Speed Change (resampling) of +1%, −1%, +5% and −5%. Both pitch and tempo change.
GSM Encoding/Decoding at Full Rate with an error-free channel and with channels with uniform BER of 10⁻³, 10⁻², and 10⁻¹, with no error protection.

The excerpts were 2.4 seconds long, except for the excerpts used to test resampling, which were 3.5 seconds long (resampling becomes a more difficult impairment with lengthy excerpts, as the original and resampled samples get more and more out of alignment.)

To estimate BER for these samples, the fingerprints were computed for the short excerpt and each of the impairment samples. Then, the fingerprint for each impairment was evaluated in two ways: (1) By comparison to the fingerprint from the unimpaired excerpt. (2) By comparison to the best-matching fingerprint segment from the original whole-track fingerprint.

These two values may be different due to small block-offset errors. That is, assume the whole-track fingerprint was computed at a frame rate of T=50 Hz. Thus, the fingerprint frames correspond to block starting points of 0, 20 ms, 40 ms, and so forth. Imagine that a random excerpt is drawn beginning at 30 ms; that is, it spans the interval 0.03-2.03 s within the original signal. Each fingerprint frame in this excerpt will correspond to a frame that overlaps the frames in the original by 10 ms. The best match in the sense (2) will be either to the block beginning at 0.02, or the one beginning at 0.04, but is unlikely to be a perfect match since the parameters are interpolated.

The first sort of comparison will be termed an “aligned” comparison; aligned comparisons are directly comparable to the test results on the Haitsma et al. [6] set presented above (all of the comparisons in that test are aligned comparisons). The second sort of comparison is “unaligned”, and is in many ways more realistic as an example of BER that could be expected in real-world scenarios (since aligned, unimpaired comparison signals are not available in the real world).

Finally, for each trial, a random excerpt was drawn from another piece of music to test the average BER between non-corresponding pieces of music.

Results from this test, showing the means and standard deviations over the 1000 trials, are shown in Table 4.

TABLE 4
Mean and Standard Deviation Bit Error Rates For
1000 Randomized Trials

| Impairment | Aligned | Unaligned | P (False Pos) |
|---|---|---|---|
| Other music | 0.484 ± 0.020 | 0.421 ± 0.013 | |
| Original excerpt | 0.000^{a} | 0.076 ± 0.035 | <10⁻¹² |
| MP3 @ 128 Kbps | 0.029 ± 0.012 | 0.076 ± 0.034 | <10⁻¹² |
| MP3 @ 32 Kbps | 0.093 ± 0.022 | 0.107 ± 0.027 | <10⁻¹² |
| Allpass | 0.035 ± 0.016 | 0.078 ± 0.030 | <10⁻¹² |
| Echo | 0.181 ± 0.017 | 0.198 ± 0.021 | <10⁻¹² |
| Noise SNR = 20 dB | 0.049 ± 0.027 | 0.095 ± 0.035 | <10⁻¹² |
| Noise SNR = 10 dB | 0.136 ± 0.042 | 0.158 ± 0.041 | 5.66 × 10⁻¹⁰ |
| Noise SNR = 5 dB | 0.210 ± 0.046 | 0.222 ± 0.044 | 7.61 × 10⁻⁶ |
| Noise SNR = 0 dB | 0.294 ± 0.041 | 0.299 ± 0.039 | 0.00156 |
| Noise SNR = −5 dB | 0.372 ± 0.031 | 0.372 ± 0.028 | 0.0591 |
| Noise SNR = −10 dB | 0.429 ± 0.021 | 0.419 ± 0.013 | 0.447 |
| Linear speed +1% | 0.128 ± 0.025 | 0.112 ± 0.025 | <10⁻¹² |
| Linear speed −1% | 0.127 ± 0.025 | 0.111 ± 0.025 | <10⁻¹² |
| Linear speed +5% | 0.412 ± 0.035 | 0.339 ± 0.027 | 0.00298 |
| Linear speed −5% | 0.400 ± 0.035 | 0.326 ± 0.028 | 0.000927 |
| GSM, BER = 0 | 0.116 ± 0.016 | 0.140 ± 0.024 | <10⁻¹² |
| GSM, BER = 10⁻³ | 0.136 ± 0.024 | 0.158 ± 0.026 | <10⁻¹² |
| GSM, BER = 10⁻² | 0.249 ± 0.041 | 0.259 ± 0.038 | 3.08 × 10⁻⁵ |
| GSM, BER = 10⁻¹ | 0.425 ± 0.027 | 0.411 ± 0.016 | 0.320 |

^{a}The BER is zero by definition in this case.

Referring to Table 4, a few points are notable. First, for the easy impairments—MP3 coding, allpass filter, quiet noise, and clean GSM—the alignment error dominates the real error caused to the impairment. The alignment error could be reduced by ensuring smoother fingerprint signals; for example, by running the method according to the present invention at a higher block rate (at the cost of requiring larger fingerprints and more computation). Second, for the most difficult impairments (lots of noise or GSM error), the unaligned match is better. This is just because, in these cases, it sometimes happens that there is randomly a better match somewhere else in the signal than the poor match given by the aligned block. The unaligned BER in these cases simply approaches the unaligned “other music” rate. Finally, for linear speed change, unaligned matches are much better, because the best alignment for matching is with the midpoints of the matching excerpt, not the beginning.

The rightmost column of Table 4 gives the probability of finding a false-positive best match between a segment with a particular impairment and a different track. That is, imagine selecting a random two-second segment from the database and a random, nonmatching, track. The right column shows the probability that (by chance) the best blockwise match from the nonmatching track is a better match than the best blockwise match from the matching track. This probability is estimated by assuming that the BERs are random variables drawn from normal distributions with the means and variances shown in the table. Using these data, we can see that there is no real matching for the Noise SNR=−10 dB and GSM BER=10⁻¹ conditions; the probability of false positive is not significantly different from chance levels. The case of Noise SNR=−5 dB is also very difficult for the system to handle.

The rightmost column can be also used to estimate the probability of obtaining one or more false-positive best matches for a two-second excerpt against a database containing many tracks, by assuming the tracks are independent trials. (This may not be strictly true since some pieces of music are similar to one another). For example, consider the condition with noise added at 5 dB SNR. In approximately one out of 130,000 trials a false positive will occur. Thus, in a database with 1000 tracks, P(FP)=0.76%; with 10,000 tracks, P(FP)=7.33%; with 100,000 tracks, P(FP)=53.28%.

These numbers can be reduced by rejecting samples as “unknown” when the BER>α for some application-appropriate cutoff. For example, with α=0.38, P(FP) is reduced for the 100,000 track database on SNR 5 dB signals to 0.05% (one trial out of 2,000), at the cost of incorrectly rejecting about one out of every 5,000 good matches.

4.2. Retrieval Testing

A second important type of test is the retrieval test. In this section, the retrieval performance is empirically measured and compared to the theoretical predictions described in the previous section.

It is unfortunately difficult to compare system-to-system results on this task, because it requires large databases of music that are not generally available for cross-system testing. For example, Allamanche and colleagues (XXX) have used a proprietary database of 15,000 rock and pop music examples loaned to them by corporate sponsors. Without using the same database in controlled circumstances, direct comparisons are not possible. A worldwide uniform standard corpus of music test data would be extremely useful for such scientific purposes. That said, once the theoretical retrieval predictions are verified, they might be extrapolated to estimate the results on tasks performed by other systems, at least where the test conditions are comparable.

An initial retrieval test focused on mixture with white noise interference. The same database of 350 two-minute tracks from the previous test was used. Segments for retrieval were selected by repeatedly taking a 2.4 sec segment from one of the music tracks, mixing it with noise, calculating a target fingerprint from the impaired segment, and matching the segment against the database of fingerprints. The SNR for noise mixing was randomly chosen to be −10 dB, −5 dB, 0 dB, 5 dB, or 10 dB.

Three tests were conducted for each of 1000 trials. The three tests represent different application characteristics borne by real-world scenarios.

In the first test, the retrieval test, the target sample was always present in the database, and the frequency with which the similarity of the target and the correct template exceeded the target threshold (thus resulting in a positive match) was measured. In the second test, the false-positive test, the target sample was removed from the database before lookup, and the frequency with which at least one other template exceeded the target threshold (thus resulting in a false positive) was measured. In the third test, the one-best test, the target sample was always present, and the frequency with which the correct template was the best match for the target (without regard to threshold) was measured. A total of 1000 randomized trials were run. For the first two tests, the retrieval threshold was set at α=0.380.

Table XXX shows the predicted and observed results for these tests. The predicted rates are computed from the BER distributions collected in the previous section. By assuming that the BER for each iteration is an independent, normally distributed random variable, the overall probabilities of retrieval and false positive are calculated by integrating the normal distribution and exponentiating over the number of elements in the test set (350). The probabilities of one-best match were estimated by Monte Carlo simulation using these distributions.

TABLE 5
Predicted and Observed Retrieval Results for Two-Second Samples in Noise,
α = 0.380

| | Retrieval | | False Positive | | One Best | |
|---|---|---|---|---|---|---|
| SNR | Predicted | Observed | Predicted | Observed | Predicted^{a} | Observed |
| −10 dB | 0.16% | 0.50% | 20.3% | 0% | 0.66% | 23.0% |
| −5 dB | 60.6% | 61.5% | 20.3% | 0% | 65.4% | 90.0% |
| 0 dB | 98.0% | 96.3% | 20.3% | 2.8% | 98.4% | 99.1% |
| 5 dB | 99.98% | 99.0% | 20.3% | 10.1% | 100% | 100% |
| 10 dB | 100% | 100% | 20.3% | 28.9% | 100% | 100% |

^{a}These values were estimated by Monte Carlo simulation and are not analytically precise.

As can be seen in Table 5, the trends in the observed retrieval results are quite close to the predicted results. The largest difference comes in the number of false-positive results. The estimated false-positive results (using the statistics from Table 4) were generated by comparing two unimpaired pieces of music to each other. If, on average, the fingerprints of two pieces of music are more similar than the fingerprint of a piece of music and a noisy sound, then this would account for the overestimates of false positive rate. This hypothesis is supported by the fact that as the impairment becomes less critical (as the SNR increases), the false positive rate approaches the estimated rate. The overestimated false-positive rate is also responsible for the better-than-expected one-best rate. Overall, this test supports the data in Table 4 as a useful worst-case bounds for estimating retrieval rates in unknown scenarios.

The results in Table 5 seem quite strong—in particular, at 5 dB and 10 dB SNR, only a single trial failed to be retrieved correctly, and at and above 0 dB SNR, the one-best rate was 99.7% (two misses in 600 trials). Given these results, a more difficult test was conducted. In this test, other impairments were included, and the length of the target segment ranged randomly from 0.5 sec to 4.5 sec, in order to determine the effect of the target length on retrieval accuracy.

The target signal was impaired in one of four ways:
Noise Addition with uniform white noise with SNR ranging from −10 dB to 10 dB.
Dialogue Mixing with a segment of a popular TV program (“The Simpsons”) containing speech and sound effects, with signal-to-interference ratio ranging from −10 dB to 10 dB RMS.
GSM Encoding/Decoding at Full Rate with the channel impaired by uniform BER ranging from 10⁻⁵ to 10⁻¹, with no error protection.
Linear Speed Change (resampling) ranging from −10% to +10%. Both pitch and tempo change.

Many of these circumstances are extremely challenging. It seems unlikely that even human listeners could consistently identify music tracks from half-second excerpts embedded in noise 10 dB louder. It should be considered important in evaluating fingerprinting systems not only to confirm that the system works correctly in easy cases, but also to determine and examine the failure modes. By collecting statistics across a number of randomized trials, the performance can be examined as a function of a number of signal and interference characteristics.

Results from this experiment over 5270 total trials are shown in FIG. 11. In this figure, each data point represents the proportion of trials meeting one of the test criteria over a range of conditions, with the x-value of the point as the midpoint of the range. For example, in the upper left figure (noise by impairment), the one-best retrieval rate of 62% at −5 dB shows that 62% of 122 trials with SNR ranging from −6 dB to 4 dB met the one-best criterion.

As with the previous experiment, the rejection threshold a was set at BER=0.38. Some points of note:
1. Mixing with dialogue is, overall, the most difficult of these tasks. It is the only impairment in which the retrieval rate doesn't reach the ceiling of 100%, regardless of the level of impairment. A hypothesis for this is that it is due to the nature of the signal-to-interference measurement used here. For broadband noise, the sound energy is spread out all over the spectrum, while for dialogue at equivalent power level, the sound energy is concentrated in a more narrowband region. This means that when the target sound occupying the same narrowband region as the dialogue, the masking effect of the dialogue will be higher than the masking effect of a broadband noise with equivalent power.

[image]

FIG. 11: Retrieval Performance.

For each of the four impairment conditions, the retrieval performance is plotted by difficulty of impairment (left) and length of test segment (right).

The three curves in each figure show the retrieval rate (proportion of trials in which the matching template has BER below α=0.38), false positive rate (proportion of trials in which at least one nonmatching template has BER below a), and one-best rate (proportion of trials in which the matching template has the lowest BER). Each plotted point is the proportion of trials that met the test criterion over a range of conditions with that x-value as the midpoint.
2. False positive rejection with α=0.38 is poor unless the segment length is 2 sec or more. To a first approximation, the false-positive rate depends only on the length of the target segment, not on the level of impairment. (A slight effect consistent with the result of the previous experiment can be seen for the noise impairment). This is predictable from the BER measurements shown in Table 3. The α level was set relatively high here in order not to hit the 0% floor for short segments. As a result of the high likelihood of false matches, the one-best rate is also poor for very short segments.
3. Speed change less than +/−5%, noise with SNR greater than 0 dB, and GSM with BER less than 10⁻³ are unproblematic for this system, with retrieval and one-best rates at the ceiling.
4. As expected, speed change performance decreases with increasing sample length (as the target and template get more and more out of alignment). The optimum segment length for one-best matching where speed change is present is from 0.8 to 1.6 sec.

An important feature of the data collected in this experiment that cannot be seen in the graphs in FIG. 11 is that virtually all of the mismatches come in difficult trials. Consider the upper-left figure again (noise by impairment level). The 62% best-one-match point at −5 dB SNR represents the average performance over all lengths of segment—from 0.5 to 4.5 sec. It turns out that all of the mismatches in this sample come from the short segments, less than 1.2 sec. There are no one-best mismatches at −5 dB SNR when the target segment is longer than 1.2 sec.

This point is illustrated graphically in

FIG. 12. For each of the impairment conditions, all of the data (the same data shown FIG. 11) are graphed in scatterplot form, where each point representing one trial. The hits (trials on which the template with lowest BER compared to the target was the correct match) are visually distinguished from the misses. As can be seen in these graphs, there are very few errors over most of the condition space—all of the misses are concentrated in the most difficult trials. In particular:
1. For noise, the one-best rate was 99.5% (3 misses out of 558 trials) when the length of the sample was greater than 1.2 sec and the SNR was greater than −5 dB. In addition, there was only one more mismatch when the SNR was greater than 2 dB and the length of the sample was greater than 0.75 sec.
2. For dialogue, the one-best rate was 99.4% (2 misses out of 309 trials) when the length of the sample was greater than 2 sec and the signal-to-interference ratio was greater than −2.5 dB. Notice that there were many more misses between −5 dB STI and −2.5 dB STI in the case of dialogue interference as compared to noise interference.
3. For GSM, the one-best rate was 99.7% (2 misses out of 595 trials) when the length of the sample was greater than 1 sec and the BER was less than 10⁻². There were also only two misses out of 619 trials when the BER was less than 10⁻³ regardless of segment length.
4. For speed change, the one-best rate was 99.9% (one miss out of 678 trials) when the amount of speed change was less than +/−5%.

The thresholds here were set by hand in order to illustrate this characteristic of the retrieval behavior. By running more trials, it would be possible to use density-estimation techniques to measure the probability of match in any desired region of the condition space.

[image]

FIG. 12: Accuracy on Subset Conditions.

The four subplots represent the four error conditions. Each trial is shown as one data point—plotted in gray if the trial met the “one best” criterion (a hit) or in black if it did not (a miss). Virtually all of the misses are concentrated in the difficult cases—either high impairment, or short segment, or both. For each of the types of interference, the accuracy rates are extremely high within a subset of the trial conditions (shown by superimposed lines). For noise, the one-best rate is 99.5% when the length of the sample is greater than 1.2 sec and the SNR is greater than −5 dB. For dialogue, the one-best rate is 99.4% when the length of the sample is greater than 2 sec and the SNR is greater than −2.5 dB. For GSM, the one-best rate is 99.7% when the length of the sample is greater than 1 sec and the BER is less than 10⁻². For speed change, the one-best rate is 99.9% when the change is less than +/−5%.

4.3. Soundtrack Matching

A third set of tests was conducted in order to evaluate the performance in soundtrack matching using the Viterbi method described in Section 3.2. In this test, random soundtracks (dialogue with sporadic background music) were generated, and then processed by the soundtrack-matching system, to determine the retrieval and false-positive rates and the accuracy with which the start and end times of background music can be estimated.

For each of 500 trials, a random two-minute soundtrack was generated using the following procedure. Two dialogue tracks, each 20 sec long, taken from popular television shows formed the interference. The dialogue tracks contain sound effects and laugh track in addition to speech from several speakers. These dialogue tracks were randomly alternated back to back for two minutes to create the interference. Randomly selected music—from the same 350-track database—was mixed into the interference track from time to time. The average length of a musical cue ranged from 4 to 20 sec, and the average time between musical cues ranged from 0 to 10 sec. The mixing level ranged from 5 to −20 dB, expressed as a signal-to-interference ratio. Music at −20 dB is barely audible to the human listener, as it is largely masked by the dialogue; typical mixing levels for broadcast programming (for example, for sports highlight shows) range from −XXX to −XXX dB (XXX). A schematic of a typical soundtrack is shown in Figure XXX.

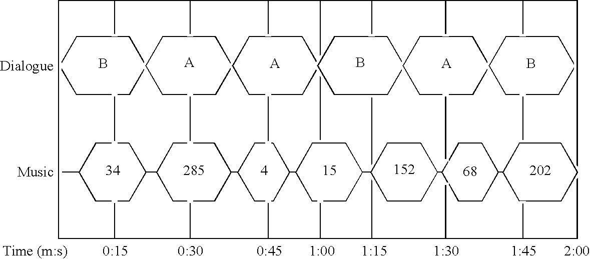

4.4. Speed Versus Accuracy with Optimized Search

A final set of tests examined the scalability, in accuracy and time, of the fingerprint-retrieval method according to the present invention s. Both the brute-force search method according to the present invention and the optimized method presented in Sec. 3.3 were tested. However, the overall test must be considered preliminary, as not enough sound examples were available to test scalability in large databases. Instead, the scaling was examined on smaller databases and used to project runtimes and accuracy for large ones.

The test setup was similar to that presented for the retrieval test in Sec. 4.2. Sound segments were taken from the database and mixed with noise. The impaired segments were fingerprinted, and matching fingerprints searched for in the template database. For this test, only noise interference was used. All test segments were 2 sec long. The template database ranged in size from 70 min of music to 560 min of music, and was created for each case by taking a subset of the full 350-segment (700 min) database used in the foregoing tests.

Retrieval was tested for the brute-force method according to the present invention and the optimized method according to the present invention with allowable error depth ranging from 1 bit/frame to 6 bits/frame. Two interference conditions were used—one with noise at 5 dB SNR (the “easy” test) and one with noise at −5 dB SNR relative to the target sound (the “difficult” test). For each retrieval test (database, search method, and interference condition) 500 randomized trials were run. The run time and retrieval accuracy were computed for each test. One-best retrieval results will be presented, as this is the condition that scales most poorly with increasing database size. Run times were generated on an 800 MHz Pentium III computer with 128 MB of RAM running Microsoft Windows ME.

| Search | | | | | 10,000 min | 1,000,000 min |
|---|---|---|---|---|---|---|
| mode | 70 min | 140 min | 280 min | 560 min | (projected) | (projected) |
| Brute | 2.93 sec/ | 3.46 sec/ | | 8.38 sec/ | | |
| force | trial | trial | | trial | | |
| Optimized, | 2.01 sec/ | | | 2.13 sec/ | | |
| error level 1 | trial | | | trial | | |
| Optimized, | 2.03 sec/ | | | 2.21 sec/ | | |
| error level 2 | trial | | | trial | | |
| Optimized, | 2.18 sec/ | | | 2.27 sec/ | | |
| error level 3 | trial | | | trial | | |
| Optimized, | 2.96 sec/ | 3.19 sec/ | | 3.52 sec/ | | |
| error level 4 | trial | trial | | trial | | |
| Optimized, | 7.23 sec/ | 7.88 sec/ | | 9.45 sec/ | | |
| error level 5 | trial | trial | | trial | | |
| Optimized, | 27.3 sec/ | | | 38.1 sec/ | | |
| error level 6 | trial | | | trial | | |
| Brute | 90% | 94.2% | | 87.4% | | |
| force | | | | | | |
| Optimized, | 6.6% | | | 1.2% | | |
| error level 1 | (.073) | | | (.014) | | |
| Optimized, | 14.4% | | | 8.0% | | |
| error level 2 | (.16) | | | (.091) | | |
| Optimized, | 29.2% | | | 24.8% | | |
| error level 3 | (.32) | | | (.28) | | |
| Optimized, | 54.8% | 56.4% | | 47.0% | | |
| error level 4 | (.61) | | | (.54) | | |
| Optimized, | 76.8% | | | 68.2% | | |
| error level 5 | (.85) | | | (.78) | | |
| Optimized, | 89.2% | | | 84.2% | | |
| error level 6 | (.99) | | | (.96) | | |

5. Summary and Conclusions

### REFERENCES

[1] J. Beerends, “Audio quality determination based on perceptual measurement techniques,” in Applications of Digital Signal Processing to Audio and Acoustics, M. Kahrs and K. Brandenburg, Eds. New York: Kluwer Academic, 1998, pp. 39-83.
[2] K. Brandenberg, “Perceptual coding of high quality digital audio,” in Applications of Digital Signal Processing to Audio and Acoustics, M. Kahrs and K. Brandenburg, Eds. New York: Kluwer Academic, 1998, pp. 39-83.
[3] S. C. Kenyon, L. J. Simkins, L. L. Brown, and R. Sebastian, “Broadcast signal recognition system and method”. United States Patent assigned to Ensco, Inc, 1984.
[4] S. C. Kenyon, L. J. Simkins, and R. L. Sebastian, “Broadcast information classification system and method”. U.S. Pat. No. 4,843,562, assigned to Broadcast Data Systems, 1989.
[5] W. J. Pielemeier, G. H. Wakefield, and M. H. Simoni, “Time-frequency analysis of musical signals,” Proc IEEE, vol. 84, pp. 1216-1230, 1996.
[6] J. Haitsma, T. Kalker, and J. Oostveen, “Robust Audio Hashing for Content Identification,” presented at Second International Workshop on Content Based Multimedia and Indexing, Brescia, IT2001.
[7] E. Allamanche, J. Herre, O. Hellmuth, B. Froeba, and M. Cremer, “AudioID: Towards content-based identification of audio material,” presented at 110th Convention of the Audio Engineering Society, Amsterdam2001.
[8] E. Allamanche, J. Herre, O. Hellmuth, B. Froeba, T. Kastner, and M. Cremer, “Content-based identification of audio material using MPEG-7 low level description,” presented at Second Annual International Symposium on Music Information Retrieval, Bloomington, Indiana2001.
[9] O. Hellmuth, E. Allamanche, J. Herre, T. Kastner, M. Cremer, and W. Hirsch, “Advanced audio identification using MPEG-7 content description,” presented at 111th Convention of the AES, New York2001.
[10] D. Fragoulis, G. Rousopoulos, T. Panagopoulos, C. Alexiou, and C. Papaodysseus, “On the automated recognition of seriously distorted musical recordings,” IEEE Transactions on Signal Processing, vol. 49, pp. 898-908, 2001.
[11] T. Kalker, J. Haitsma, and J. Oostveen, “Issues with digital watermarking and perceptual hashing,” presented at Proceedings of SPIE—Multimedia Systems and Applications IV, Denver, Colo.2001.
[12] E. D. Scheirer, Music-Listening Systems. Ph.D.Thesis, Institution, Cambridge, Mass., 2000.
[13] R. Cole and R. Hariharan, “Approximate string matching: A simpler faster method according to the present invention,” presented at ACM-SIAM Symposium on Discrete Method according to the present invention s, pp. 463-472, 1998.
[14] A. Gionis, P. Indyk, and R. Motwani, “Similarity search in high dimensions via hashing,” presented at 25th Int. Conf. on Very Large Databases, Edinburgh1999.
[15] C. W. Therrien, Decision, Estimation and Classification: An Introduction to Pattern Recognition and Related Topics. New York: Wiley, 1989.
[16] J. Haitsma, personal communication, 2002.

1. A method for waveform recognition comprising the steps of audio fingerprinting at least one known piece of music, audio fingerprinting at least one unknown piece of music, and identifying said at least one unknown piece of music by comparing its audio fingerprint with the audio fingerprint of said at least one known piece of music.
